(19) United States
(12) Patent Application Publication
(10) Pub. No.: US 2012/0134507 A1
(43) Pub. Date: May 31, 2012

(54) Methods, Systems, and Products for Voice Control

(76) Inventors: DIMITRIOS B. DIMITRIADIS, Jersey City, NJ (US); Horst J. Schroeter, New Providence, NJ (US)

(21) Appl. No.: 12/956,012

(22) Filed: Nov. 30, 2010

(51) Int. Cl. H04R 3/00; G10L 21/00

(52) U.S. Cl. 381/92; 704/275

(57) ABSTRACT

Methods, systems, and computer program products provide voice control of electronic devices. Speech and a beacon signal are received. A directional microphone is aligned to a source of the beacon signal. A voice command in the speech is received and executed.

### NOTICE OF COPYRIGHT PROTECTION

A portion of the disclosure of this patent document and its figures contain material subject to copyright protection. The copyright owner has no objection to the facsimile reproduction by anyone of the patent document, but otherwise reserves all copyrights whatsoever.

### BACKGROUND

Exemplary embodiments generally relate to communications, acoustic waves, and speech signal processing and, more particularly, to distance or direction finding and to directive circuits for microphones.

Voice recognition is known for controlling televisions, computers, and other electronic devices. Conventional voice recognition systems, though, often suffer from degradation due to environmental noise. When multiple people are conversing in a room, conventional voice recognition systems overreact from unintended commands.

### BRIEF DESCRIPTION OF THE SEVERAL VIEWS OF THE DRAWINGS

The features, aspects, and advantages of the exemplary embodiments are better understood when the following Detailed Description is read with reference to the accompanying drawings, wherein:

FIG. 1 is a simplified schematic illustrating an environment in which exemplary embodiments may be implemented;

FIGS. 2 and 3 are more detailed schematics illustrating a voice-activated system, according to exemplary embodiments;

FIG. 4 is a more detailed block diagram illustrating voice control, according to exemplary embodiments;

FIG. 5 is a flowchart illustrating a method for voice control, according to exemplary embodiments;

FIG. 6 is a generic block diagram of a processor-controlled device, according to exemplary embodiments; and

FIG. 7 depicts other possible operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

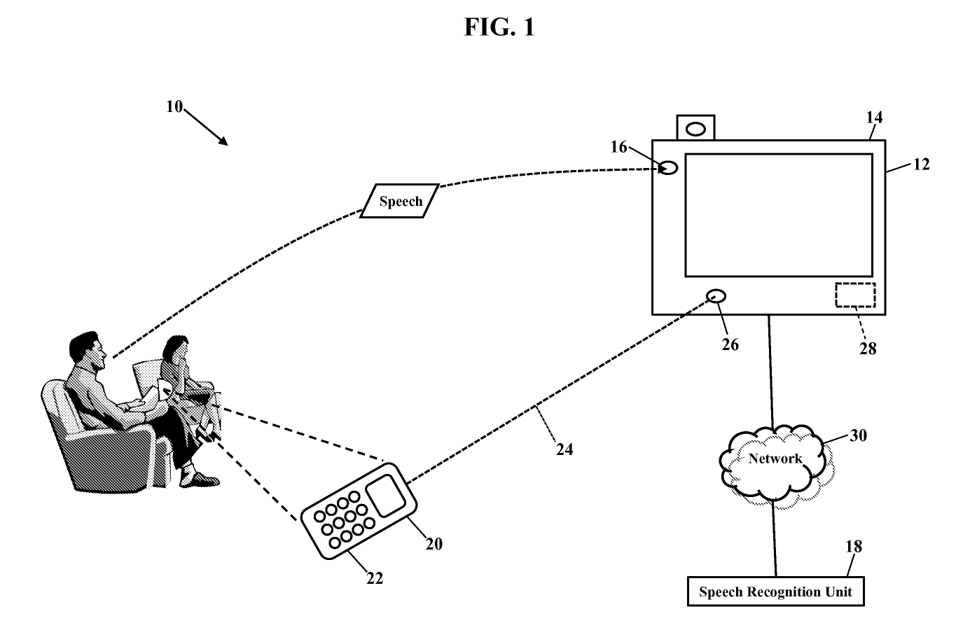

FIG. 1 is a simplified schematic illustrating an environment in which exemplary embodiments may be implemented. FIG. 1 illustrates a voice-activated system 10 for remotely controlling an electronic device 12. The electronic device 12 is illustrated as a television 14, but the electronic device 12 may be a computer, stereo, or any other processor-controlled device (as later paragraphs explain). A user speaks audible speech (such as audible voice commands), and the audible voice commands are received by a directional microphone 16. The directional microphone 16 captures speech signals, and the speech signals are sent to a speech recognition unit 18. When the speech recognition unit 18 detects a voice command in the speech signals, then the speech recognition unit 18 sends the voice command to some destination for execution. The voice command, for example, may be an audible command to change a channel, access a website, change a volume, or any other command.

The voice-activated system 10 may include a mobile device 20. FIG. 1 illustrates the mobile device 20 as a remote control 22. The mobile device 20, however, may be a phone, tablet computer, smart phone (such as IPHONE®), personal digital assistant, or any other processor-controlled device (as later paragraphs explain). The mobile device 20 may be held and carried by the user that speaks the voice commands. The remote control 22 transmits a separate beacon signal 24 to a separate sensor 26. The beacon signal 24 indicates a presence or location of the remote control 22 being held by the user. The steering direction of the directional microphone 16 is controlled using the beacon signal 24.

A locator mechanism 28 uses the beacon signal 24 to steer the directional microphone 16. When the separate sensor 26 receives the beacon signal 24, the separate sensor 26 may convert the beacon signal 24 into an electrical signal. The locator mechanism 28 analyzes the electrical signal produced from the beacon signal 24 and uses software to adjust, or aim, the directional microphone 16 toward the source of the beacon signal 24. The locator mechanism 28, in other words, uses the beacon signal 24 to steer the directional microphone 16. As the user moves and carries the remote control 22, the locator mechanism 28 keeps the directional microphone 16 steered to a source of the beacon signal 24.

The locator mechanism 28 helps isolate speech. The locator mechanism 28 directionally aligns the directional microphone 16 to the remote control 22 emitting the beacon signal 24. Even if multiple people are in the vicinity of the television 14, the locator mechanism 28 uses software to emphasize voice signals from the user holding the remote control 22. The directional microphone 16 is thus focused on the location of a master or priority user possessing the remote control 22. Speech from users not holding the remote control 22, in other words, is suppressed and less likely to command the electronic device 12 (e.g., the television 14). The software suppresses human speech and/or noise sources that are not in the direction of the beacon signal 24. The software, in other words, isolates sounds in the direction of the beacon signal 24. These software techniques are known to those of ordinary skill in the art and need not be further explained.

FIG. 1 illustrates the speech recognition unit 18 as being remotely accessed via a communications network 30. The speech recognition unit 18 is likely an expensive and complicated apparatus. Most speech recognition units execute several software routines and require significant processing capabilities. FIG. 1, then, illustrates the speech recognition unit 18 as a separate functional and physical component from the electronic device 12 (e.g., the television 14). Because the speech recognition unit 18 is complicated, the speech recognition unit 18 is preferably remotely maintained, accessed, and queried using the communications network 30. The speech recognition unit 18 may thus be reliably maintained by experts. Exemplary embodiments, however, may combine the speech recognition unit 18 into the electronic device 12, and/or the speech recognition unit 18 may be a component in a home network.

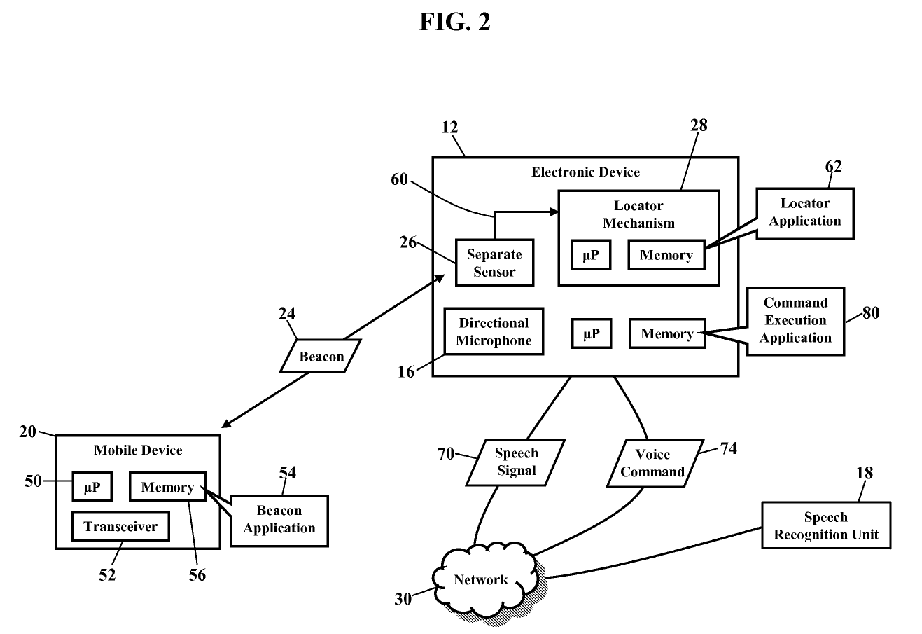

FIG. 2 is a more detailed schematic illustrating the voice-activated system 10, according to exemplary embodiments. FIG. 2 illustrates the mobile device 20 sending the beacon signal 24 to the electronic device 12. The mobile device 20 has a processor 50 (e.g., “μP”), application specific integrated circuit (ASIC), or other component that interfaces with a transceiver 52. The processor 50 executes a beacon application 54 stored in a memory 56. The beacon application 54 is a set of software commands or code that instruct the processor 50 to have the transceiver 52 transmit the beacon signal 24. The beacon signal 24 may be may be infrared signals, radio frequency signals, optical signals, acoustic signals (within the audible range), or be within any portion of the electromagnetic spectrum. The beacon signal 24, for example, may be at an ultrasound frequency (exceeding a common human audible threshold range, such as approximately 20,000 Hz.). If the beacon signal 24 is at an ultrasound frequency, then the separate sensor 26 may be a separate microphone that receives ultrasound frequencies. Regardless, the beacon signal 24 may also be a periodic or random pulse or a continuously broadcast signal.

The beacon signal 24 is received by the separate sensor 26. The separate sensor 26 may convert the beacon signal 24 into a digital or analog output signal 60. The output signal 60 is received by the locator mechanism 28. The locator mechanism 28 has a processor (e.g., “μP”), application specific integrated circuit (ASIC), or other component that executes a locator application 62 stored in a memory. The locator application 62 is a set of software instructions or code that command the processor to directionally steer the directional microphone 16. The locator mechanism 28 uses the beacon signal 24, and thus the output signal 60, to suppress voice signals not in the direction of the source of the beacon signal 24. The locator mechanism 28 thus uses the output signal 60 to aim the directional microphone 16 based on a position of the mobile device 20.

The locator application 62 may use any method or technique for aligning the directional microphone 16 to the beacon signal 24. The locator application 62, for example, may use known beamforming techniques to orient the directional microphone 16. The locator application 62 may additionally or alternatively measure signal, noise, and/or power to aim the directional microphone 16 in a direction of greatest signal strength or power.

The locator application 62 emphasizes voice signals in the direction of the beacon signal 24. Because the locator application 62 determines the location of the mobile device 20, speech and other sounds from other directions may be suppressed. The directional microphone 16 receives the user's spoken speech and converts the speech into a speech signal 70. The speech signal 70 may be processed and sent over the communications network 30 to the speech recognition unit 18. The speech recognition unit 18 may interpret the semantic content of the speech signal 70. The speech recognition unit 18 discerns a voice command 74 contained within the speech signal 70. Because the speech recognition unit 18 may execute any known method or procedure of discerning the semantic content of the speech signal 70, this disclosure need not further discuss the speech recognition unit 18.

The electronic device 12 may execute the voice command 74. If the voice command 74 is destined for the electronic device 12 (such as the television 14), then the voice command 74 may be returned to the electronic device 12. As FIG. 2 illustrates, once the speech recognition unit 18 discerns the voice command 74, the speech recognition unit 18 may send the voice command to an Internet Protocol address associated with the electronic device 12. The electronic device 12 may have a processor (e.g., “μP”), application specific integrated circuit (ASIC), or other component that executes a command execution application 80 stored in a memory. The command execution application 80 is a set of software instructions or code that cause the processor to receive the voice command 74 and to execute the voice command 74. The voice command 74 may cause the electronic device 12 to select content, such as change a channel, download a website, or play a movie. The command execution application 80, however, may execute any command capable of being verbalized, such as changes in volume, selecting inputs, installing/formatting components, or changing display characteristics.

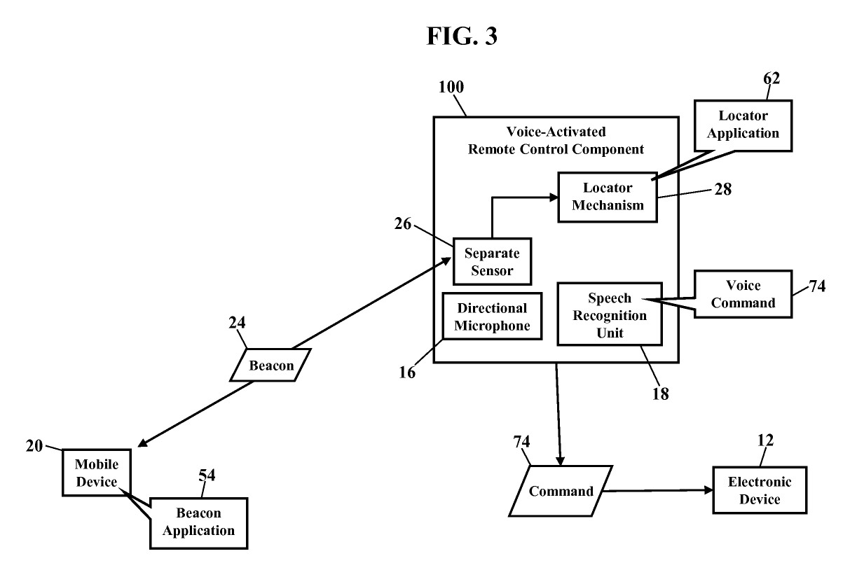

FIG. 3 is another schematic illustrating the voice-activated system 10, according to exemplary embodiments. Here the locator mechanism 28 and the speech recognition unit 18 may be functionally combined into a single, stand-alone component 100. As the above paragraphs explained, currently the speech recognition unit 18 is expensive and complicated, so the speech recognition unit 18 may be remotely maintained, accessed, and queried using the communications network (illustrated as reference numeral 30 in FIGS. 1 and 2). FIG. 3, though, illustrates that the speech recognition unit 18 may be a component in a home network. The user's audible speech, and the beacon signal 24, are received, and the user's audible speech is interpreted. The voice command 74 is discerned and communicated to the separate electronic device 12. The beacon signal 24 is again used to directionally steer the directional microphone 16 (as the above paragraphs explained). The single, voice-activated remote control component 100 is thus illustrated as a separate component that uses voice activation to control the electronic device 12. The speech recognition unit 18, in other words, may be a component of a set-top box, a receiver, or controller that uses speech recognition to control the electronic device 12. The single, voice-activated remote control component 100 may be purchased as a stand-alone component that interfaces with any electronic device (such as the television 14, stereo, computer, and other electronic devices in the home or office).

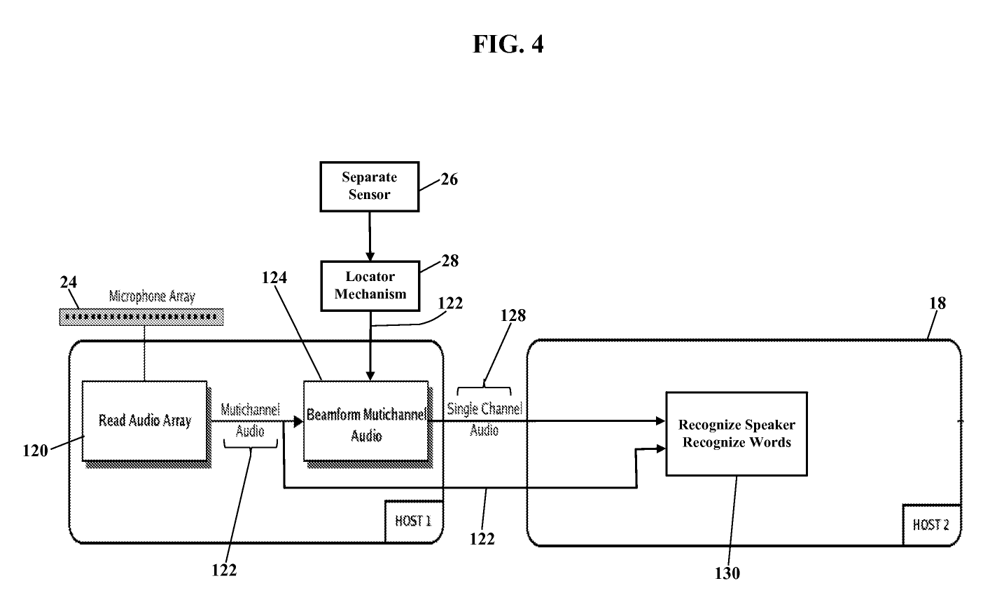

FIG. 4 is a more detailed block diagram illustrating voice control, according to exemplary embodiments. The separate sensor 26 receives the beacon signal 24, and the directional microphone 16 receives speech. FIG. 4 illustrates the directional microphone 16 as an array of microphones. The array of microphones may comprise any number of microphones operating in tandem. The array of microphones may be used in many applications, such as extracting voice input from ambient noise (notably telephones, speech recognition systems, hearing aids) and in recording high fidelity audio. Multiple microphones within the array of microphones may improve signal quality of audible voice commands from the user of the mobile device 20. The array of microphones is read (Block 120) and a multichannel audio output 122 is generated. The locator mechanism 28 performs a beamforming process (Block 124) on the multichannel audio output 122 and steers the array of microphones to emphasize speech in the direction of the mobile device 20. The beamforming process (Block 124) produces a single channel audio output 128. The single channel audio output 128 may then be sent as an input to the speech recognition unit 18 (perhaps via the communications network 30, as illustrated in FIGS. 1 and 2). The speech recognition unit 18 may analyze the single channel audio output 128 to identify or recognize words and even a speaker holding the mobile device 20 (Block 130). Additionally or alternatively the multichannel audio output 122 may also be sent as another input to the speech recognition unit 18 (again perhaps via the communications network 30). The speech recognition unit 18 may analyze the multichannel audio output 122 to identify or recognize words and the speaker holding the mobile device 20 (Block 130). The semantic content of either or both the single channel audio output 128 and the multichannel audio output 122 may be discerned (such as recognizing the voice command 74, as illustrated in FIG. 2). Exemplary embodiments may utilize known de-noising, beamforming, and automatic speech recognition techniques, such as any combination of recognition results from multiple channel audio (e.g., one channel per microphone).

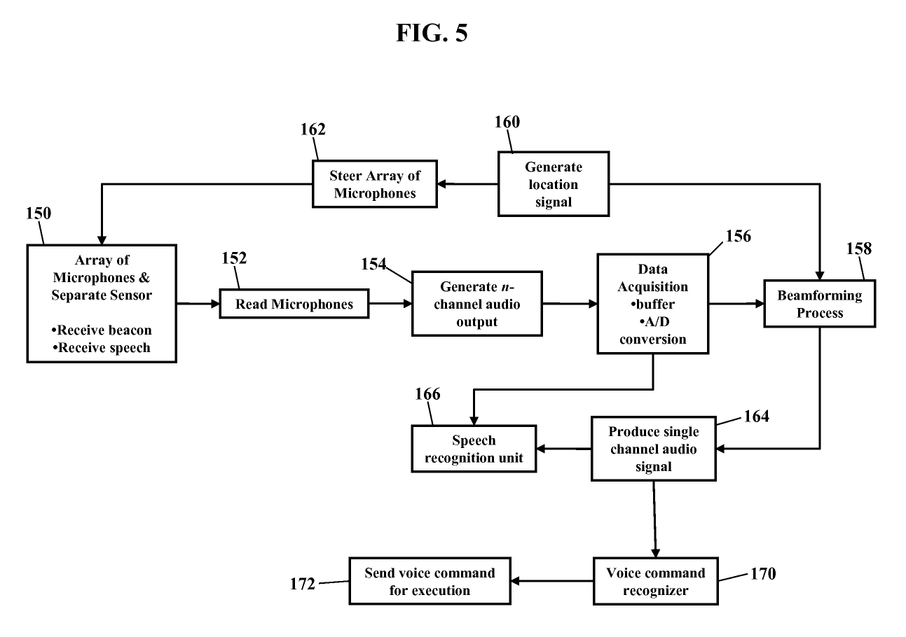

FIG. 5 is a flowchart illustrating a method for voice control, according to exemplary embodiments. The separate sensor 26 receives the beacon signal 24 from the mobile device 20 (Block 150). The array of microphones also receives the audible speech from the user of the mobile device 20 (Block 150). The array of microphones is read (Block 152) and the speech signal 70 is generated as an n-channel audio output (Block 154). The array of microphones may include any number of uni-directional microphones and/or any number of omni-directional microphones. A data acquisition component receives the n-channel audio output, buffers to memory, and performs any analog-to-digital conversion (Block 156). A digital n-channel audio output is received at the locator mechanism 28 and the beamforming process performed (Block 158). The location signal 132 is generated (Block 160) and is fed back to steer the array of microphones toward the mobile device 20 (Block 162). The beamforming process produces the single channel audio output (Block 164), which is input to the speech recognition unit 18 (Block 166). One or more voice commands may be recognized (Block 170). Speech recognition may be held upon any or all audio channels, and a final result may be a combination of individual results. While the speech recognition unit 18 may perform any automatic speech recognition process, exemplary embodiments may use the WATSON® speech recognition engine from AT&T. The recognized voice command 74 may then be sent for execution (Block 172).

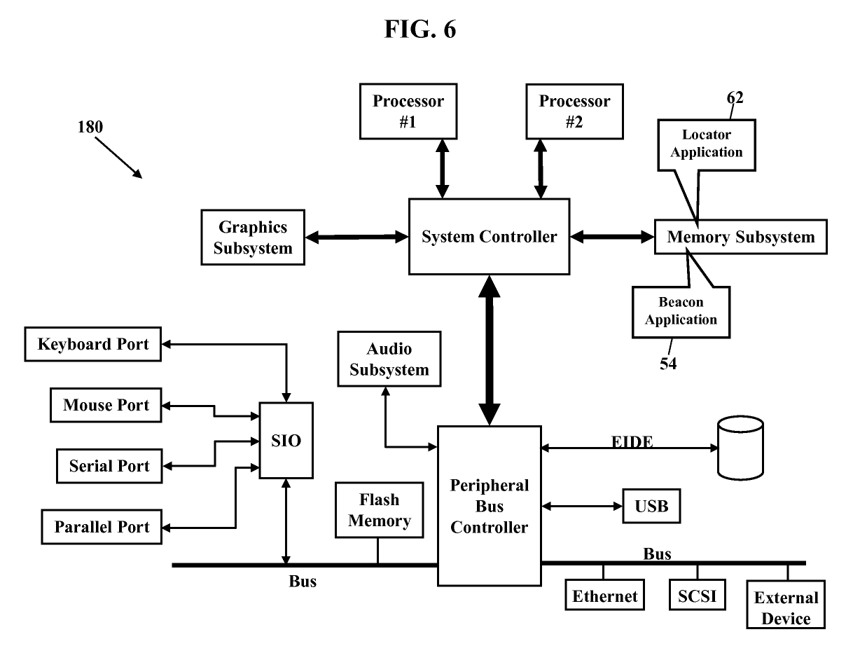

FIG. 6 is a schematic illustrating still more exemplary embodiments. FIG. 6 is a generic block diagram illustrating the beacon application 54 and the locator application 62 operating within a processor-controlled device 180. As the above paragraphs explained, the beacon application 54 and the locator application 62 may operate in any processor-controlled device 180. FIG. 6, then, illustrates the beacon application 54 and the locator application 62 stored in a memory subsystem of the processor-controlled device 180. One or more processors communicate with the memory subsystem and execute either application. Because the processor-controlled device 180 illustrated in FIG. 6 is well-known to those of ordinary skill in the art, no detailed explanation is needed.

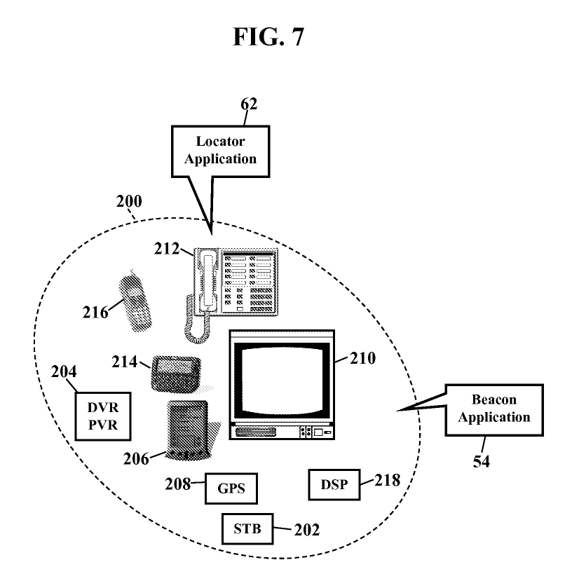

FIG. 7 depicts other possible operating environments for additional aspects of the exemplary embodiments. FIG. 7 illustrates the beacon application 54 and/or the locator application 62 operating within various other devices 200. FIG. 7, for example, illustrates that either application may entirely or partially operate within a set-top box (“STB”) (202), a personal/digital video recorder (PVR/DVR) 204, personal digital assistant (PDA) 206, a Global Positioning System (GPS) device 208, an interactive television 210, an Internet Protocol (IP) phone 212, a pager 214, a cellular/satellite phone 216, or any computer system, communications device, or processor-controlled device utilizing the processor 50 and/or a digital signal processor (DP/DSP) 218. The device 200 may also include watches, radios, vehicle electronics, clocks, printers, gateways, mobile/implantable medical devices, and other apparatuses and systems. Because the architecture and operating principles of the various devices 200 are well known, the hardware and software componentry of the various devices 200 are not further shown and described.

Exemplary embodiments may be physically embodied on or in a computer-readable storage medium. This computer-readable medium may include CD-ROM, DVD, tape, cassette, floppy disk, memory card, and large-capacity disks. This computer-readable medium, or media, could be distributed to end-subscribers, licensees, and assignees. These types of computer-readable media, and other types not mention here but considered within the scope of the exemplary embodiments. A computer program product comprises processor-executable instructions for using voice and beacon technology to control electronic devices, as explained above.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method for voice control of an electronic device, comprising:
receiving speech;
receiving a beacon signal;
aligning a directional microphone to a source of the beacon signal;
receiving a voice command in the speech; and
executing the voice command.

2. The method according to claim 1, wherein receiving the beacon signal comprises receiving an ultrasonic beacon signal at a separate microphone.

3. The method according to claim 1, further comprising converting the speech into a speech signal.

4. The method according to claim 3, further comprising analyzing a semantic content of the speech signal.

5. The method according to claim 1, further comprising performing a beamforming process.

6. The method according to claim 1, further comprising querying a speech recognition unit.

7. The method according to claim 6, further comprising receiving the voice command from the speech recognition unit.

8. A system, comprising:
a processor executing code stored in memory, the code causing the processor to:
receive a beacon signal;
receive multi-channel audio;
beamform the multi-channel audio to produce single channel audio;
steer an array of microphones to a source of the beacon signal; and
query a speech recognition unit.

9. The system according to claim 8, further comprising code that causes the processor to receive a voice command discerned from at least one of the single channel audio and the multi-channel audio.

10. The system according to claim 9, further comprising code that causes the processor to execute the voice command.

11. The system according to claim 8, further comprising code that causes the processor to suppress a portion of the multi-channel audio.

12. The system according to claim 8, further comprising code that causes the processor to emphasize a portion of the multi-channel audio in a direction of the source.

13. The system according to claim 8, further comprising code that causes the processor to analyze a semantic content.

14. A computer readable medium storing processor executable instructions for performing a method, the method comprising:
receiving a beacon signal;
generating multi-channel audio;
beamforming the multi-channel audio to produce single channel audio;
steering an array of microphones toward a source of the beacon signal; and
querying a speech recognition unit.

15. The computer readable medium according to claim 14, further comprising instructions for receiving a voice command from the speech recognition unit.

16. The computer readable medium according to claim 15, further comprising instructions for executing the voice command.

17. The computer readable medium according to claim 15, further comprising instructions for suppressing a portion of the multi-channel audio.

18. The computer readable medium according to claim 15, further comprising instructions for emphasizing a portion of the multi-channel audio in a direction of the source.

19. The computer readable medium according to claim 15, further comprising instructions for suppressing a portion of the multi-channel audio.

20. The computer readable medium according to claim 15, further comprising instructions for analyzing a semantic content.
